(19) United States
(12) Patent Application Publication
(10) Pub. No.: US 2026/0109555 A1
(43) Pub. Date: Apr. 23, 2026

(54) COUPLERS THAT COUPLE ROTATABLE ROBOTIC ARMS AND ROTATABLE VACUUM-ASSISTED END OF ARM TOOLS

(71) Applicant: Walmart Apollo, LLC, Bentonville, AR (US)

(72) Inventors: Gerald J. Byers, Springfield, MO (US); Shane T. Shelbourn, Pea Ridge, AR (US); Tomas A. Blodgett, Fayetteville, AR (US)

(21) Appl. No.: 19/361,397

(22) Filed: Oct. 17, 2025

Related U.S. Application Data
(60) Provisional application No. 63/709,799, filed on Oct. 21, 2024.

(51) Int. Cl. B65G 47/91

(52) U.S. Cl. CPC B65G 47/91

(57) ABSTRACT

A coupler for coupling a vacuum source to a rotatable tool coupled to an end of a rotatable robotic arm for moving at least one object includes a first portion coupled to both the rotatable tool and the rotatable robotic arm. The first portion and the rotatable tool are configured to rotate in response to rotation of the end of the robotic arm. The first portion includes a first conduit passing therethrough and being in communication with the vacuum source. The coupler further includes a second portion that does not rotate during rotation of the rotatable robotic arm and the rotatable tool. The coupler further includes a second conduit configured to couple to a first end of a flexible tube having a second end thereof coupled to the vacuum source. The second conduit does not rotate during the rotation of the rotatable robotic arm and the rotatable tool.

### CROSS-REFERENCE TO RELATED APPLICATIONS

This application claims the benefit of U.S. Provisional Application No. 63/709,799, filed Oct. 21, 2024, which is incorporated herein by reference in its entirety.

### TECHNICAL FIELD

This invention relates generally to end of arm tools and, more specifically, to couplers that facilitate rotatable coupling of end of arm tools with rotatable robotic arms.

### BACKGROUND

An end-of-arm tool (EoAT) generally refers to a device or tool that is attached to the end of a robotic arm or manipulator. An EoAT is often used to move objects from one location to another. In some conventional approaches, an EoAT is operatively coupled to a vacuum source via a hose, thereby facilitating the EoAT to use vacuum force to lift, hold, and move objects. However, the addition of a vacuum hose assembly to the EoAT assembly may limit the range of motion of the EoAT and/or the robotic manipulator. In addition, rotational movement of the robotic manipulator and/or the EoAT may cause the vacuum hose to twist and/or kink, which could interfere with the ability of the EoAT to lift, hold, and move objects.

### BRIEF DESCRIPTION OF DRAWINGS

Disclosed herein are embodiments of systems, apparatuses and methods pertaining to devices and methods for object manipulation. This description includes drawings, wherein:

FIG. 1 depicts a perspective view of a vacuum-assisted object manipulation device that includes a rotatable tool coupled to an end of a rotatable robotic arm via a coupler in accordance with some embodiments;

FIG. 2 depicts a perspective view of the object manipulation device of FIG. 1, but showing a close-up, enlarged view of the end portion of the rotatable robotic arm, the coupler, and the rotatable tool that is coupled to the rotatable robotic arm and is oriented generally horizontally;

FIG. 3 depicts the same view as FIG. 2, but shows the rotatable tool as having been rotated by about 45 degrees relative to its position in FIG. 2, while also showing that second portion of the coupler that is coupled to the vacuum hose has not rotated as a result of the rotatable tool having been so rotated;

FIG. 4 depicts the same view as FIG. 2, but shows the rotatable tool as having been rotated by about 90 degrees relative to its position in FIG. 2, while also showing that second portion of the coupler that is coupled to the vacuum hose has not rotated as a result of the rotatable tool having been so rotated;

FIG. 5 is a perspective, partially exploded view of the object manipulation device of FIG. 2, showing the coupler being separated from the end portion of the rotatable robotic arm and from the rotatable tool;

FIG. 6 shows a front perspective view of the coupler in accordance with some embodiments;

FIG. 7 shows a side perspective view of the coupler in accordance with some embodiments;

FIG. 8 is a front perspective exploded view of the coupler of FIG. 6 in accordance with some embodiments;

FIG. 8A is an enlarged, perspective view of the first portion of the coupler isolated from FIG. 8 in accordance with some embodiments;

FIG. 9 is a perspective view of a second conduit having a rectangular cross-section along its entire length in accordance with some embodiments; and

FIG. 10 is a flowchart depicting an example method of moving at least one object in accordance with some embodiments.

### DETAILED DESCRIPTION

Generally, a coupler for coupling a vacuum source to a rotatable tool coupled to an end of a rotatable robotic arm for moving at least one object includes a first portion coupled to both the rotatable tool and the rotatable robotic arm. The first portion and the rotatable tool rotate in response to the rotation of the end of the rotatable robotic arm. The first portion includes a first conduit passing therethrough and in fluid communication with the vacuum source. The coupler further includes a second portion that does not rotate during the rotation of the rotatable robotic arm and the rotatable tool. The coupler further includes a second conduit that couples to a first end of a flexible tube (for example, a hose) having a second end thereof coupled to the vacuum source. The second conduit and the flexible tube (for example, a hose) coupled thereto do not rotate during the rotation of the rotatable robotic arm and the rotatable tool.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

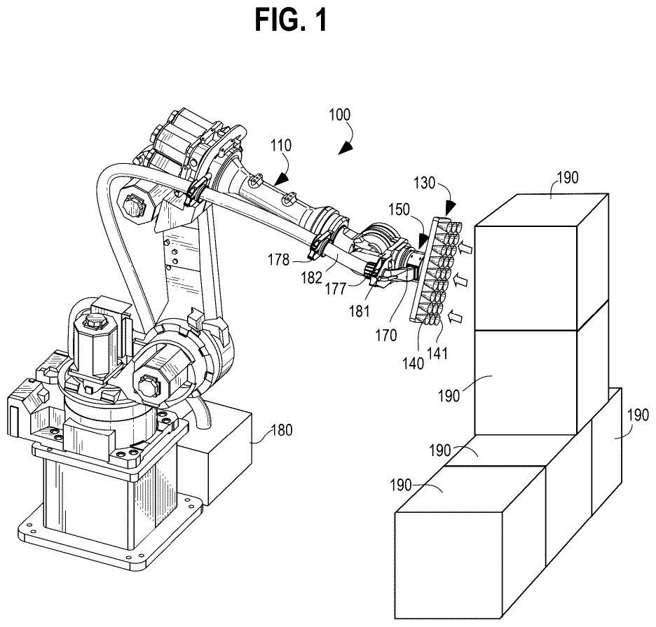

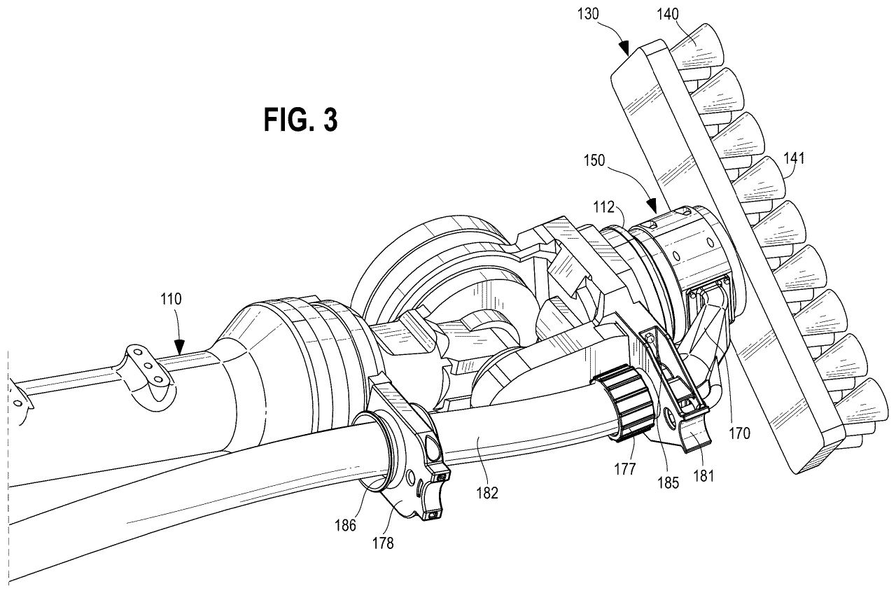

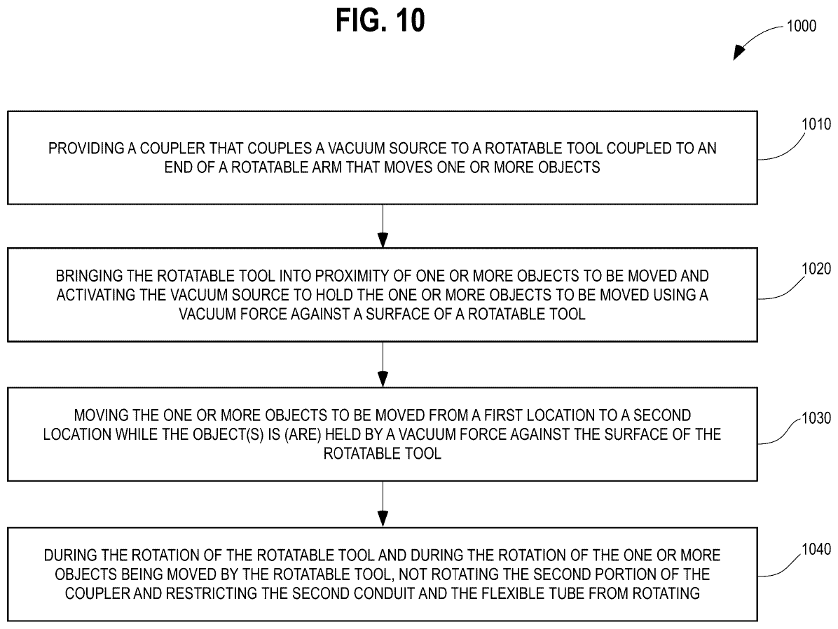

Various embodiments and examples of couplers that facilitate the coupling of vacuum-assisted rotatable end of arm tools to rotatable robotic arms are described herein. Generally, FIGS. 1-9 are provided to illustrate a coupler according to some embodiments, and FIG. 10 illustrates a flow chart of a method of an example method of moving one or more objects using robotic arm that is connected to an end of arm tool via a coupler according to some embodiments.

FIG. 1 depicts a system 100 for moving one or more objects 190 according to some embodiments. The system 100 illustrated in FIG. 1 includes a linearly and rotatably movable robotic arm 110 for lifting, holding, and moving objects. In the example shown in FIG. 1, the robotic arm 110 is shown in a retail environment, where the robotic arm 110 may be used to unload a stack of objects 190, which may be also referred to herein as boxes, cases, totes, etc., and which may contain one or more retail products therein. In the illustrated embodiment, a rotatable robotic arm 110 is coupled to a rotatable end of arm tool 130 via a coupler 150 (a portion of which rotates and a portion of which does not rotate, as will be discussed in more detail below). The coupler 150, which is coupled to the robotic arm 110 and to the end of arm tool 130 (thus interconnecting the robotic arm 110 and the end of arm tool 130) is also coupled to a vacuum source 180 via a flexible hose 182 (which may be more generically referred to herein as a “flexible tube”).

In some embodiments of the system 100, the vacuum source 180 may be located adjacent to (or in proximity to) a base of the assembly that includes the robotic arm 110 as shown in FIG. 1. In other embodiments of the system 100, to save space and/or reduce the footprint of the assembly that includes the robotic arm 110, the vacuum source 180 may be incorporated into the overall structure of the assembly that includes the robotic arm 110.

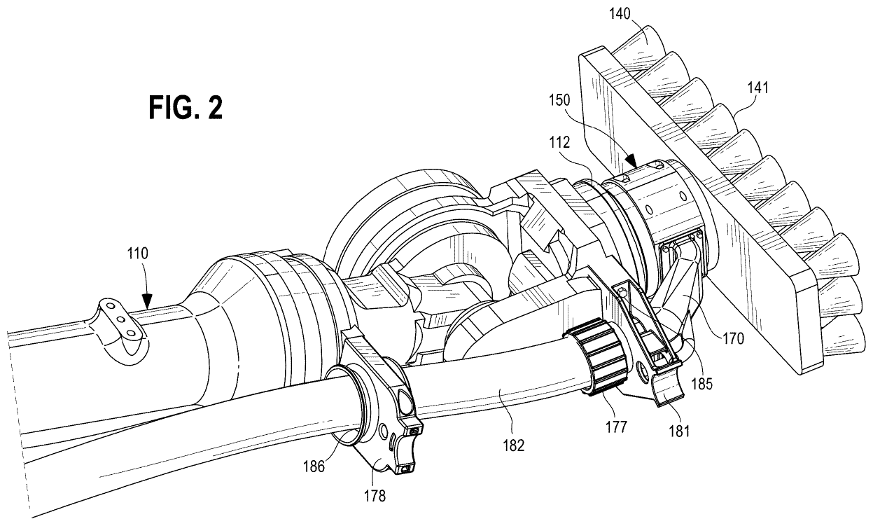

With reference to FIGS. 2-4, the coupler 150 includes a first portion 152 coupled to the rotatable end of arm tool 130 and to the rotatable robotic arm 110. In some aspects, the first portion 152 of the coupler 150 is coupled to an end 112 of the robotic arm 110 and performs the function of a rotatable shaft that rotates in response to rotational motion of the robotic arm 110, and that translates the rotational motion of the robotic arm 110 into corresponding rotational motion of the rotatable end of arm tool 130 (to which the coupler 150 is coupled as well) as will be discussed in more detail below.

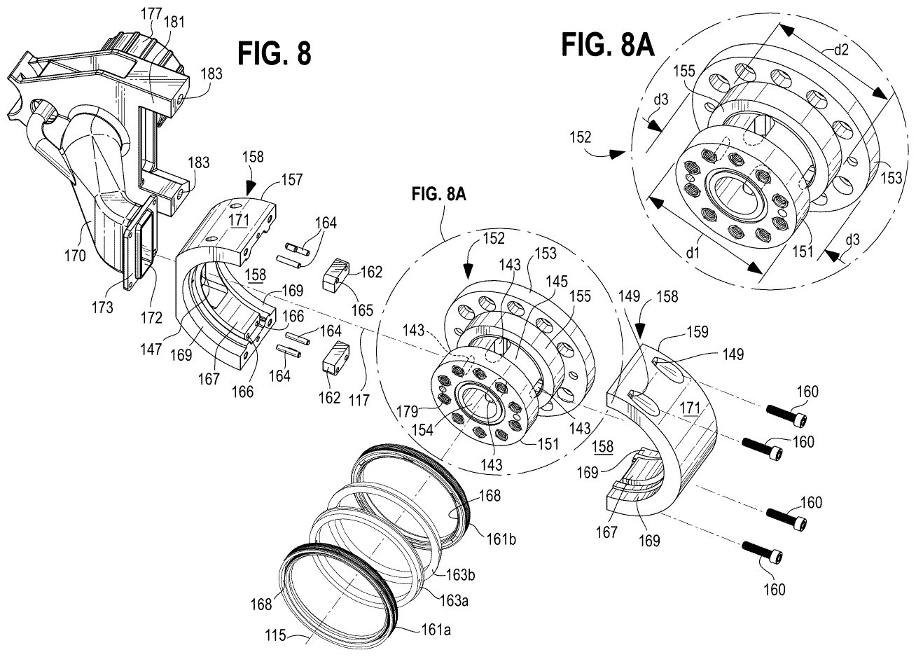

With reference to FIG. 8, the first portion 152 of the coupler 150 has a first spindle 151, a second spindle 153 located opposite of the first spindle 153, and a third spindle 155 located between the first spindle 151 and the second spindle 153. In the embodiment shown in FIG. 8, each of the first spindle 151, second spindle 153, and third spindle 155 of the first portion 152 of the coupler 150 is generally circular. In addition, in the embodiment illustrated in FIG. 8A (which depicts an enlarged version of the second portion 152 isolated from FIG. 8), the relative dimensions of the first, second, and third spindles 151, 153, and 155 of the coupler 150 are such that first spindle 151 has a first dimension d1 (e.g., a diameter), the third spindle 155 has a third dimension d3 (e.g., a diameter) that is identical to the first dimension d1 (it will be appreciated that the dimensions d1 and d3 do not have to be the same), while the third spindle 155 has a second dimension d2 (e.g., diameter) that is larger than each of the first dimension d1 and the second dimension d3. Notably, in the embodiment shown in FIG. 8, the first portion 152 of the coupler 150 further includes an intermediate portion 145, which has fourth dimension d4 (e.g., a diameter) that is smaller than each of the first dimension d1, second dimension d2, and third dimension d3.

In the embodiment illustrated in FIG. 8, the coupler 150 includes a first bearing 161a that surrounds at least a portion of the exterior circumference of the first spindle 151 and a second bearing 161b that surrounds at least a portion of the exterior circumference of the third spindle 155. In the illustrated embodiment, the first portion 152 is formed as a single unitary piece integrally including the first, second, and third spindles 151, 153, and 155, which advantageously allows the coupler 150 to be simpler to manufacture (by including less hardware) and to have a reduced overall size and weight, which advantageously lessens the moments as well as the strain and wear and tear on the robotic arm 110 that moves the coupler 150 and objects 190 over time.

With reference to the embodiment of FIG. 8, to facilitate smooth rotation of the first portion 152 of the coupler 150, the coupler 150 includes a first bearing 161a and a second bearing 161b. In the illustrated embodiment, at least a part of the first bearing 161a is positioned around the circumference of the first spindle 151 of the first portion 152 of the coupler 150, and at least a part of the second bearing 161b is positioned around the circumference of the third spindle 155 of the first portion 152 of the coupler 150.

The coupler 150 shown in FIG. 8 further includes a first seal 163a (which may be referred to herein as a “seal” or a “rotary shaft seal”) located adjacent to the first bearing 161a and at least partly positioned around the exterior circumference of the first spindle 151. In addition, the coupler 150 shown in FIG. 8 includes a second seal 163b (which may be referred to herein as a “seal” or a “rotary shaft seal”) located adjacent to the second bearing 161b and at least partly positioned around the exterior circumference of the third spindle 155. In some aspects, the first and second seals 163a, 163b seal the area around the first portion 152 (which is akin to a rotating shaft) of the coupler 150, and act to restrict any lubricants or fluids from escaping from the sealed area while also keeping any dirt and debris out of the sealed area, thereby advantageously reducing wear on the first portion 152 of the coupler 150.

In some embodiments, the first and second seals 163a, 163b are spring-loaded and may include a spring that maintains constant biasing toward/pressure against the first portion 152 (i.e., the rotating shaft portion) of the coupler 150, thereby enabling the first and second seals 163a, 163b to provide a tight seal with respect to the first portion 152 of the coupler 150. In the illustrated embodiment, each of the first and second seals 163a, 163b includes a wiper lip 168, which may help sweep away contaminants from the exterior surface of the first portion 152 of the coupler 150 when the first portion 152 of the coupler 150 rotates, thereby reducing the risk of contaminants entering the sealed area (which, if not restricted/prevented, may contribute to excessive wear and/or failure of the rotating first portion 152 of the coupler 150).

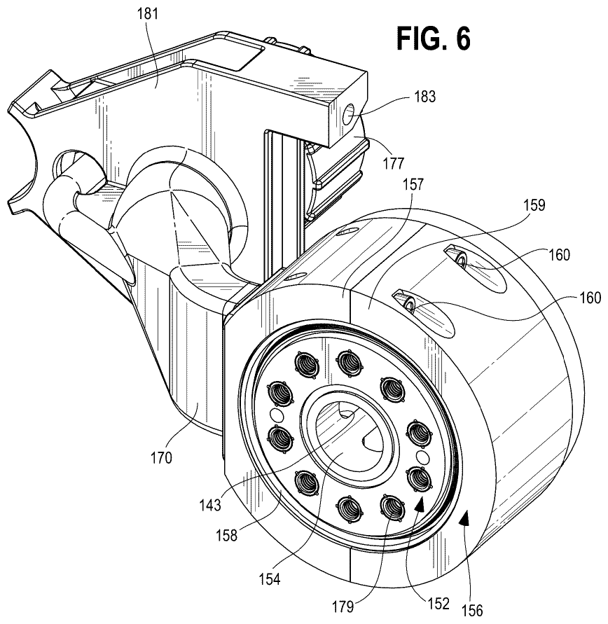

With reference to FIGS. 6-8, the first portion 152 of the coupler 150 includes a first conduit 154 (i.e., an opening, channel, etc. that permits the flow of a fluid such as air) passing through a portion thereof. As will be discussed in more detail below, the first conduit 154 of the first portion 152 of the coupler 150 is in fluid communication with the suction cups 140 of the end of arm tool 130 (as will be discussed in more detail below), and in fluid communication with vacuum source 180 via a second conduit 170 of the second portion 156 of the coupler 150 and via the flexible tube or hose 182 (which is directly coupled to the vacuum source 180 at one end and to the second conduit 170 at its other end, as will be discussed in more detail below). Notably, in some embodiments, the flexible tube or hose 182 is not used to translate a vacuum force from the vacuum source 180 to the rotatable end of arm tool 130. In some aspects, the system 100 may include one or more flexible tubes or hoses 182 with one or more of an electrical connector, an ethernet connector, and/or a pneumatic connector passing therethrough.

In the illustrated embodiment, the coupler 150 includes a second portion 156. In some aspects, the second portion 156 of the coupler 150 is fixedly mounted relative to a non-rotatable portion of the rotatable robotic arm 110 such that the second portion 156 of the coupler 150 does not rotate during the rotation of the rotatable robotic arm 110, and/or the rotation of the first portion 152 of the coupler 150, and/or the rotation of the rotatable end of arm tool 130.

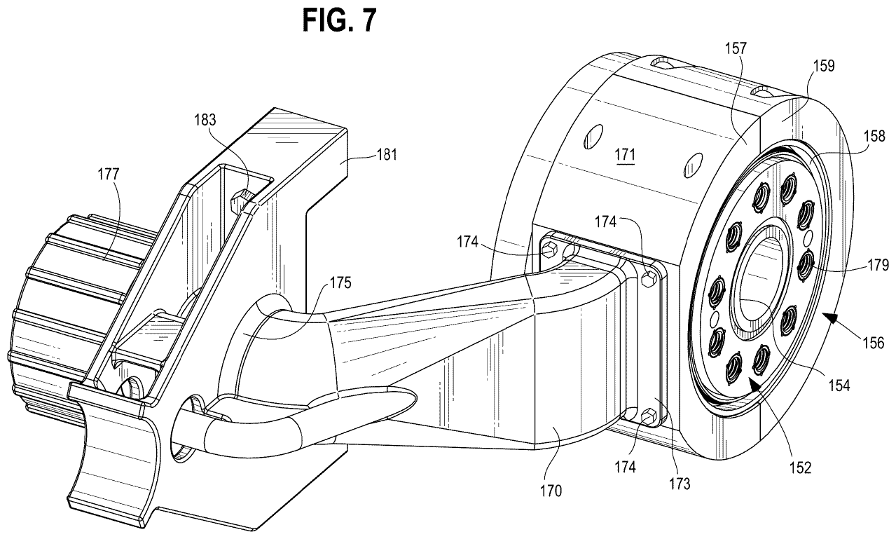

With reference to FIGS. 6-8, the second portion 156 of the coupler 150 includes a hollow cylindrical interior 158 and is positioned around the first portion 152 such that the first portion 152 is fully contained within the hollow cylindrical interior 158 of the second portion 156. In other words, in the embodiment shown in FIGS. 6-7, no portion of the first portion 152 of the coupler 150 extends out of (i.e., outwardly from) the hollow cylindrical interior 158 of the second portion 156 of the coupler 150. Without wishing to be limited to theory, such a configuration may advantageously contribute to a compact size and/or reduced weight of the coupler 150. Without wishing to be limited to theory, a reduction in overall length of the coupler 150 in a direction along the central longitudinal axis 115 keeps more weight of the coupler 150 closer to the end 112 of the robotic arm 110 and less of the weight of the coupler 150 away from the end 112 of the robotic arm, which advantageously reduced the moment and makes it easier for the robotic arm 110 to lift and move the objects 190, improves the efficiency and/or speed of the robotic arm 110, and reduces the wear and tear on the robotic arm 110, which may lower maintenance costs and improve reliability (i.e., reduce failures) of the robotic arm 110.

With reference to FIG. 8, the second portion 156 of the coupler 150 includes a first hollow semicylinder (e.g., c-shaped) portion 157 and a second hollow semicylinder (e.g., c-shaped) portion 159. As shown, for example, in FIGS. 7 and 8, the first hollow semicylinder portion 157 is attached to the second semicylinder portion 159 to form the hollow cylindrical interior 158 of the second portion 156 of the coupler 150. In the embodiment illustrated in FIG. 8, each of the two hollow semicylinder portions 157, 159 of the second portion 156 of the coupler 150 has an interior surface 167 facing the hollow cylindrical interior 158 of the second portion 156 and including one or more grooves 169 sized and shaped to receive a complementary sized and shaped exterior-facing surface of the first portion 152. For example, one of the grooves 169 of the interior surface 167 of the second portion 156 may receive an exterior-facing surface representing the exterior circumference of the first spindle 151 of the first portion 152, and another one of the grooves 169 of the interior surface 167 of the second portion 156 may receive an exterior-facing surface representing the exterior circumference of the second spindle 153 of the first portion 152.

In the embodiment illustrated in FIG. 8, the first and second hollow semicylinder portions 157, 159 are attached to each other via fasteners 160 (which may pass through respective openings 149 in each of the first and second hollow semicylinder portions 157, 159). While the first and second hollow semicylinder portions 157, 159 are shown in FIG. 8 as being attached to each other via four fasteners 160 (e.g., screws, bolts, etc.), it will be appreciated that less than four (e.g., two, etc.) or more than four (e.g., six, etc.) fasteners 160 may be used to attach the first and second hollow semicylinder portions 157, 159 to each other.

In the example shown in FIG. 8, the first and second hollow semicylinder portions 157, 159 are also coupled to each other via a pair of spacers 162 and two pairs of pins 164 (e.g., dowel pins, etc.). In the embodiment shown in FIG. 8, each pin 164 of a pair of pins has one end inserted into an opening 166 of the first hollow semicylinder portion 157, passes through an opening 165 in a respective one of the spacers 162, and has a second end inserted into a complementary sized and shaped opening (not shown) of the second hollow semicylinder portion 159, which is located opposite a respective opening 166 of the first hollow semicylinder portion 157.

In the illustrated embodiment, the second portion 156 of the coupler 150 includes a second conduit 170 (i.e., an opening, channel, etc. that permits the flow of a fluid such as air) passing through a portion thereof. Just like the first conduit 154, the second conduit 170 of the second portion 156 of the coupler 150 is in fluid communication with the vacuum source 180 via the flexible tube or hose 182. As shown in FIGS. 2-4, the second conduit 170 is fixedly mounted relative to the non-rotatable portion of the rotatable robotic arm 110, such that the second conduit 170 does not rotate during the rotation of the rotatable robotic arm 110 and/or during the corresponding rotation of the first portion 152 of the coupler 150 and the rotatable end of end of arm tool 130.

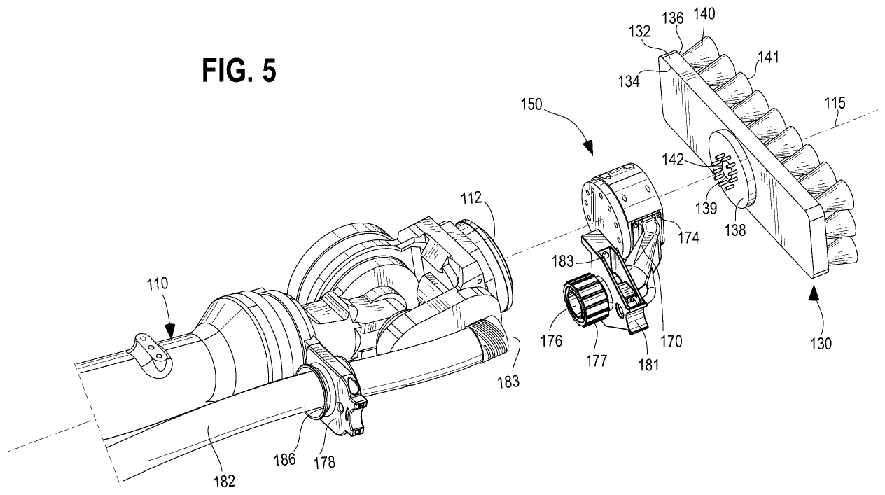

In the embodiment illustrated in FIG. 5, the second conduit 170 is attached to (or integrally formed as a unitary structure with) a bracket 181, which constrains rotational movement of the second conduit 170, as discussed in more detail below. In the illustrated embodiment, the bracket 181 is sized and shaped such that it fully wraps around (i.e., surrounds) the exterior perimeter/circumference of second conduit 170, but it will be appreciated that, in some embodiments, the bracket 181 may extend around only a portion of the second conduit 170. The example bracket 181 shown in FIG. 5 includes one or more openings 183 that permit one or more fasteners 185 (e.g., bolts, screws, etc.) to pass therethrough and thread into the non-rotatable portion of the rotatable robotic arm 110 to securely (i.e., fixedly) attach the bracket 181 and thus second conduit 170 to the non-rotatable portion of the rotatable robotic arm 110.

In other words, by virtue of the secure attachment of the bracket 181 to the non-rotatable portion of the rotatable robotic arm 110, the second conduit 170 is fixedly mounted relative to the non-rotatable portion of the rotatable robotic arm 110 such that neither the second conduit 170, nor the portion of the flexible hose 182 coupled to the distal opening 176 of the second conduit 170, is permitted to rotate during the rotation of the rotatable robotic arm 110 and the corresponding rotation of both the first portion 152 of the coupler 150 and the end of arm rotatable tool 130. As such, the segment of the flexible hose 182 proximate to the hose adapter 177 is advantageously restricted from undesirably twisting, turning, and/or kinking.

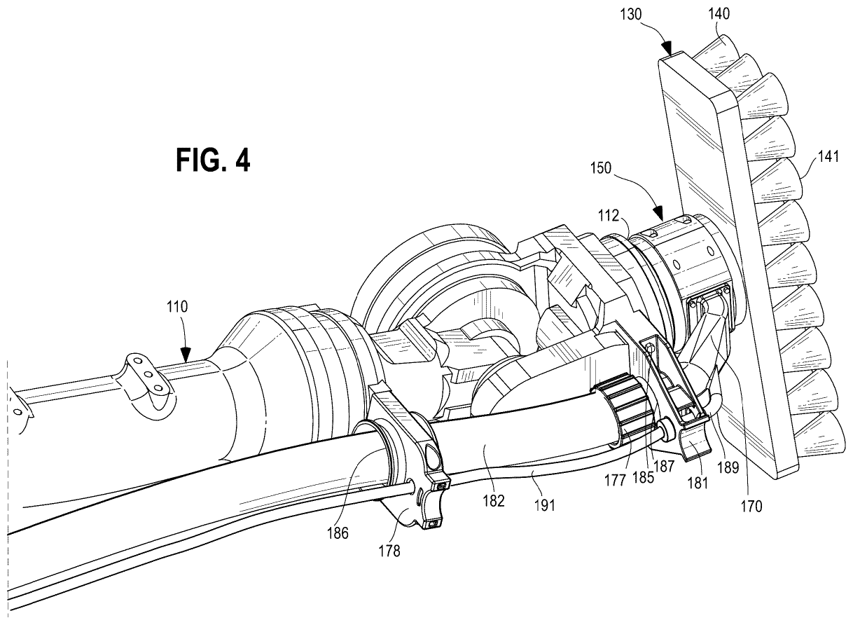

In the illustrated embodiment, the second conduit 170 extends from an exterior surface 171 of the second portion 156 and interconnects, via the bracket 181, the second portion 156 of the coupler and the non-rotatable portion of the rotatable robotic arm 110. In the implementation shown in FIGS. 4 and 5, the second conduit 170 is partly curved (and may be completely curved) and partly straight, and extends, from the exterior surface 171 of the second portion 156 toward the end 112 of the rotatable robotic arm 110 (to which the coupler 150 is attached). As shown, for example, in FIGS. 6 and 7, the second conduit 170 of the coupler 150 extends non-perpendicularly relative to the exterior surface 171 of the second portion 156, forming an acute interior angle relative to the exterior surface 171 of the second portion 156. In some implementations, the shape and orientation of the second conduit 170 in close proximity to the exterior surface 171 of the second portion 156 of the coupler 150, in combination with the location of the distal opening 176, enable a flexible hose 182 to be coupled to the hose adapter 177 at the distal opening 176 of the second conduit 170 without requiring the hose 182 to have any bends or inflections (i.e., the hose 182 may advantageously extend substantially in a straight line (and without bending by more than 45 degrees) from the vacuum source 180 to the hose adapter 177, which may eliminate kinks or other possible points of failure in the hose 182).

As shown, for example, in FIG. 5, the flexible hose 182 may be coupled to the hose adapter 177 at the distal opening 176 of the second conduit 170 such that a segment of the flexible hose 182 proximate to the distal opening 176 of the second conduit 170 (e.g., at least the segment of the flexible hose 182 located between the hose adapter 177 and the bracket 181) is oriented in parallel to both a central longitudinal axis 115 passing through the rotatable robotic arm 110, the coupler 150, and the hollow cylindrical interior 158 of the second portion 156 of the coupler 150.

As shown in FIG. 8, the second conduit 170 includes an opening 172 (also referred to herein as a “proximal opening”) at a first end 173 of the second conduit 170, which is coupled to the second portion 156 of the coupler 150. In the illustrated embodiment, the first end 173 of the second conduit 170 is attached to the first hollow semicylinder portion 157 of the second portion 156 of the coupler 150 via one or more fasteners 174 (in the example shown in FIG. 7, four bolts, screws, etc.) passing through complementary openings 188 in the first end 173 of the second conduit 170. In some aspects, the first hollow semicylinder portion 157 includes an opening 147 passing therethrough, and this opening 147 is located such that, when the first end 173 of the second conduit 170 is attached to the second portion 156 of the coupler 150 as shown in FIG. 7, the proximal opening 172 of the second conduit 170 is at least in part aligned with the opening 147. In some aspects, the proximal opening 172 and the opening 147 are fully aligned (i.e., have a substantially identical size and shape), such that an axis 117 passing through a center of the proximal opening 172 passes through a center of the opening 147 as well (this axis is shown in FIG. 8 as being transverse to the central longitudinal axis 115 passing through the first portion 152 of the coupler 150).

As mentioned above, in the embodiment shown in FIG. 8, the first portion 152 of the coupler 150 includes an intermediate portion 145. As illustrated in FIG. 8, the intermediate portion 145 of the first portion 152 of the coupler 150 includes one or more openings 143 (which are illustrated as oval but may be of any other suitable shape) passing therethrough. In the embodiment shown in FIG. 8, the proximal opening 172 of the second conduit 170 and the opening 147 of the first hollow semicylinder portion 157 and one or more (e.g., two as shown in FIG. 8) openings 143 of the intermediate portion 145 of the first portion 152 of the coupler 150 are aligned such that a single axis passing through the proximal opening 172 passes through the opening 147 and passes through one (or two as shown in FIG. 8) openings 143 of the intermediate portion 145 (as mentioned above, this axis is shown in FIG. 8 as a dashed line that is transverse to the central longitudinal axis passing through the first portion 152 of the coupler 150).

The openings 143 of the example intermediate portion 145 are in fluid communication directly with the first conduit 154 of the coupler 150 and indirectly with the second conduit 170 (i.e., via the proximal opening 172 of the second conduit 170 of the coupler 150 and the opening 147 passing through the first hollow semicylinder portion 157 of the coupler 150). In the illustrated embodiment of the system 100, the fluid communication of the second conduit 170 of the coupler 150, which is in fluid communication with the flexible hose 182 connected to the vacuum source 180, with the first conduit 154 of the coupler 150 via the openings 143 of the intermediate portion 145 of the coupler 150 enables the suction cups 140 of the rotatable end of arm tool 130 to use the suction (generated by the vacuum source 180 and transmitted via the hose 182) to grip an object 190 as shown, for example, in FIG. 1, and to move the object 190 from an initial location to an intended location while moving the object 190 linearly and/or rotationally.

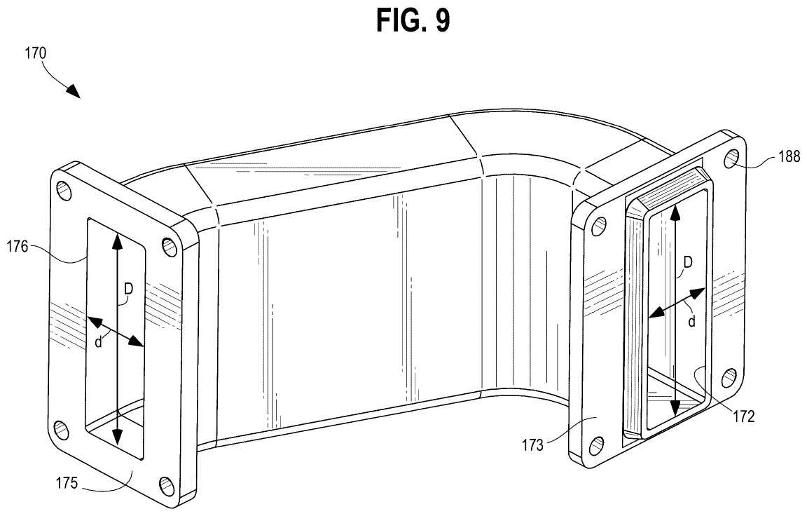

With reference to FIG. 5, at a second end 175 of the second conduit 170, which is located opposite to the first end 173 of the second conduit 170, the second conduit 170 includes an opening 176 (also referred to herein as a “distal opening”). In the embodiment illustrated in FIG. 5, the coupler 150 includes a threaded hose adapter 177 (also referred to herein as a “hose fitting”), which enables an end 187 of the hose 182, which may include threads that are complementary to the threads of the hose adapter 177 to be securely connected to the distal opening 176 of the second conduit 170. With reference to FIGS. 5 and 8, the distal opening 176 of the second conduit 170 may have an oval cross-section (see FIG. 5) and the proximal opening 172 of the second conduit 170 may have a rectangular cross-section (see FIG. 8). It will be appreciated that, in some embodiments, both the proximal opening 172 and distal opening 176 of the second conduit 170 may have an oval cross-section, while in other embodiments, both the proximal opening 172 and distal opening 176 of the second conduit 170 have a rectangular cross-section. An example second conduit 170, where the proximal opening 172 and the distal opening 176 each have a rectangular cross section is illustrated in FIG. 9.

In the embodiment illustrated in FIGS. 5-8, a segment of the second conduit 170 that is closer to the proximal opening 172 of the second conduit 170 has a rectangular cross-section, while a segment of the second conduit 170 that is closer to the distal opening 176 of the second conduit 170 has an oval cross-section. It will be appreciated that, in some embodiments, the second conduit 170 has an oval cross-section along its entire length, while, in other embodiments, the second conduit 170 has a rectangular cross-section along its entire length. FIG. 9 illustrates an example of a second conduit 170 having a rectangular cross-section along its entire length. In the embodiment illustrated in FIG. 9, a minor dimension d (minor diameter, width, etc.) of the cross-section of the distal opening 176 located at the second end 175 of the second conduit 170 extends in parallel with a radial axis of the robotic arm 110, while a major dimension D (e.g., major diameter, length, etc.) of the cross-section of the proximal opening 172 located at a first end 173 of the second conduit 170 extends perpendicularly to the radial axis of the robotic arm 110. Without wishing to be limited by theory, such relative dimensions of the major dimension D and minor dimension d of each of the proximal opening 172 and distal opening 176 advantageously limits the weight of the coupler 150 in a direction extending radially from the central longitudinal axis 115 of the coupler 150. Without wishing to be limited to theory, a reduction in weight of the coupler 150 in a direction radially away from the central longitudinal axis 115 keeps more weight of the coupler 150 closer to the end 112 of the robotic arm 110, which advantageously reduces the moments and the strain (and associated wear and tear) on the robotic arm 110 over time. In other words, conventional couplers that are bulkier and have more weight extending radially away from their centerline may increase the moments (i.e., increase the torque required by the robotic arm to move the couplers and the object(s) being moved by the robotic arm), thereby increasing the operational strain on the robotic arm coupled to such couplers over time, which may lead to reduced efficiency, reduced reliability, and higher maintenance costs.

In the example embodiment shown in FIGS. 1 and 5, the system 100 further includes a hose guide 178, which is fixedly attached to, or integrally formed as a unitary structure with, the robotic arm 110, and which includes an opening 186 that permits a portion of the flexible tube/hose 182 to pass therethrough. Without wishing to be limited by theory, the hose guide 178 advantageously restricts the segment of the tube/hose 182 proximate the hose adapter 177 from twisting, turning, and/or kinking, which would be undesirable. Notably, while the system 100 shown in FIGS. 1 and 5 includes the hose guide 178, in some embodiments, the system 100 does not include the hose guide 178. In other words, the hose guide 178 is optional in some embodiments of the system 100.

With reference to FIG. 5, in some embodiments, the rotatable end of arm tool 130 of the system 100 includes a base 132. The base 132 has a first side 134 and a second side 136 opposite the first side 134. In the illustrated embodiment, the second side 136 of the base 132 of the rotatable end of arm tool 130 includes one or more suction cups 140 (which may form a suction cup array as shown in FIG. 1) extending outwardly therefrom. The first side 134 of the base 132 of the rotatable end of arm tool 130 may include a face plate 138 with an opening 139 passing therethrough. As shown in FIG. 5, the opening 139 may be central relative to the face plate 138 such that a center of the opening 139 is at the center of the face plate 138.

In the illustrated embodiment, the opening 139 in the face plate 138 is in fluid communication with the suction cups 140. In addition, the opening 139 is in fluid communication with the first conduit 154 of the coupler 150, the second conduit 170 of the coupler 150, and the flexible hose 182 connected to the vacuum source 180. As such, in the illustrated embodiment of the system 100, as a result of the suction cups 140 being in fluid communication with the vacuum source 180 via the flexible hose 182, second conduit 170 of the coupler 150, first conduit 154 of the coupler 150, and the opening 139 of the rotatable end of arm tool 13, the suction cups 140 of the rotatable end of arm tool 130 are enabled to use the suction generated by the vacuum source 180 to grip an object 190 as shown, for example, in FIG. 1, and to move the object 190 from an initial location to an intended location while moving the object 190 linearly and/or rotationally.

In the illustrated embodiment, the face plate 138 of the rotatable end of arm tool 130 may include a number (e.g., 2, 4, 6, 8, 10 (as shown in FIG. 5), etc.) of fasteners 142 (e.g., bolts, screws, etc.) extending outwardly therefrom. These fasteners 142 may be threaded and may be received in complementary threaded openings 179 of the coupler 150 to attach the rotatable end of arm tool 130 to the coupler 150 such that the rotation of the first portion 152 of the coupler would cause a corresponding rotation of the rotatable end of arm tool 130.

In some aspects, as mentioned above, the coupler 150 acts as an intermediate connection between the rotatable robotic arm 110 of the system 100 and the rotatable end of arm tool 130 of the system 100, such that the directional movement and/or rotation of the first portion 152 of the coupler 150 and the rotatable end of arm tool 130, may be caused and/or controlled by the directional movement and/or rotation of the rotatable robotic arm 110. In some aspects, the rotatable robotic arm 110 may be a multi-axis robotic arm and the rotatable end of arm tool 130 may be a multi-axis end of arm tool. In some aspects, the rotatable robotic arm 110 includes multiple arms that are pivotally, rotatably, and/or statically attached to one another.

In some embodiments, the suction cups 140 may be oriented in an array as shown in FIG. 1 such that the suction cups 140 provide at least one gripping surface 141 that may grip (e.g., via a force provided by via the vacuum source 180) and move one or more objects 190. In the illustrated embodiment, a force provided by the vacuum source 180 may bring (e.g., pull) an object 190 located in proximity to the gripping surface 141 of the suction cups 140 into contact with the gripping surface 141, and to hold the object 190 against the gripping surface 141 of the rotatable end of arm tool 130. In particular, when the gripping surface 141 provided by the suction cups 140 of the rotatable end of arm tool 130 is brought close enough to an exterior surface of an object 190 (e.g., a box as shown in FIG. 1), the vacuum force delivered to the suction cups 140 via the vacuum source 180, the flexible hose 182, the second conduit 170 of the coupler 150, and first conduit 154 of the coupler 150 as discussed above is strong enough to pull the object 190 toward and against the gripping surface 141 of the rotatable end of arm tool 130 and to hold, lift, lower, and move (e.g., linearly, rotationally, etc.) the object 190 from an initial location to an intended location while the object 190 is held against the gripping surface 141 of the rotatable end of arm tool 130.

In some implementations, the coupler includes a third conduit 189 in fluid communication with the second conduit 170, but branching off the second conduit 170 as shown in FIG. 4. In the example embodiment shown in FIG. 4, a flexible tube or hose 191 is coupled to the third conduit 170 at its one end, coupled to an air compressor (not shown) at its other end, and extends along at least a portion of the flexible hose 182 between its ends. As shown, for example, in FIG. 4, the flexible tube or hose 191 may pass through openings in the bracket 181 and the hose guide 178, which advantageously restricts flexible tube or hose 191 from twisting, turning, and/or kinking, which would be undesirable. In some aspects, the flexible tube or hose 191 is used to facilitate (e.g., quicken) the release of the object 190 from the gripping surface 141 of the rotatable end of arm tool 130. For example, when the object 190 is brought by the gripping surface 141 of the rotatable arm tool 130 to its intended drop off location, the vacuum source 180 is turned off, and an air compressor connected to the flexible tube or hose 191 is turned on, pressurizing the system and reducing and/or fully eliminating the vacuum force delivered to the suction cups 140, such that the gripping surface 141 of the suction cups 140 releases the object 190 therefrom.

In some embodiments, the rotatable end of arm tool 130 has a freedom of rotation of up to 360 degrees about a longitudinal axis (shown as a dashed line in FIG. 5) of the rotatable robotic arm 110. In other words, in certain aspects, the rotatable end of arm tool 130 may make a full 360-degree revolution in either direction (i.e., clockwise or counterclockwise) about the longitudinal axis of the rotatable robotic arm 110. In some aspects, the degree of rotation of the rotatable end of arm tool 130 may be adjusted (e.g., by corresponding movement of the rotatable robotic arm 110) based on the initial position/orientation of the box 190 from which the box 190 is gripped by the rotatable end of arm tool 130 and/or the intended position/orientation of the box 190 into which the rotatable end of arm tool 130 will place the box 190 after moving the box 190 from its initial position/orientation. In other words, the rotatable end of arm tool 130 may grip the box 190 via the gripping surface 141 provided by the suction cups 140 from its initial position/orientation as shown in FIG. 1, then rotate the box 190 (e.g., up to 360 degrees relative to its initial orientation) while the rotatable end of arm tool 130 is moving the box 190 from its initial position to its intended position, and then place the box 190 into a different position/orientation (e.g., onto a different side of the box 190) at the intended position.

FIG. 10 is a flowchart depicting an example method 1000 of moving an object using a robotic arm, a vacuum-assisted end of arm tool, and a coupler that interconnects the robotic arm and the vacuum-assisted end of arm tool.

Step 1010 of the method 1000 includes providing a coupler that couples a vacuum source to a rotatable tool coupled to an end of a rotatable robotic arm that moves one or more objects. As discussed above, the coupler includes a first portion coupled to both the rotatable tool and the rotatable robotic arm, and the first portion and the rotatable tool rotate in response to rotation of the end of the robotic arm. In addition, the first portion includes a first conduit passing therethrough and in fluid communication with the vacuum source 180. The coupler further includes a second portion including a hollow cylindrical interior and positioned around the first portion such that the first portion is fully contained within the hollow cylindrical interior of the second portion. The second portion of the coupler is fixedly mounted relative to a non-rotatable portion of the rotatable robotic arm such that the second portion does not rotate during rotation of the rotatable robotic arm and the rotatable tool. In addition, the coupler includes a second conduit extending from an exterior surface of the second portion. The second conduit includes a proximal opening coupled to the second portion and a distal opening that couples to a first end of a flexible tube having a second end thereof coupled to the vacuum source, the second conduit being in fluid communication with the first conduit, the second conduit being fixedly mounted relative to the non-rotatable portion of the rotatable robotic arm such that the second conduit does not rotate during the rotation of the rotatable robotic arm and the rotatable tool.

Step 1020 of the method 1000 includes bringing the rotatable tool into proximity of the one or more objects to be moved and activating the vacuum source to hold the one or more objects to be moved using a vacuum force against a surface of the rotatable tool. As mentioned above, the vacuum force that enables the rotatable tool to grip, lift, lower, and move the one or more objects is provided by a vacuum hose that is coupled to a vacuum source and the coupler.

Step 1030 of the method 1000 includes moving the one or more objects to be moved from a first location to a second location while the object(s) is(are) held by the vacuum force against the surface of the rotatable tool. During the moving of the one or more objects to be moved from the first location to the second location, step 1030 of the method 1000 includes rotating the rotatable robotic arm to cause rotation of the first portion of the coupler, rotation of the rotatable tool, and rotation of the one or more objects being moved by the rotatable tool.

The example method 1000 shown in FIG. 10 further includes, during the rotation of the rotatable tool and during the rotation of the one or more objects being moved by the rotatable tool, not rotating the second portion of the coupler and restricting the second conduit and the flexible tube from rotating (see step 1040). Notably, after one or more intended objects are moved from a first location to a second location using the method 1000 described above, the steps of the method 1000 illustrated in FIG. 10 may be repeated to grip and move one or more objects 190 (e.g., the other boxes in FIG. 1) from the first location to the second location (or to a different location).

In some embodiments, a coupler for coupling a vacuum source to a rotatable tool coupled to an end of a rotatable robotic arm for moving at least one object includes a first portion coupled to both the rotatable tool and the rotatable robotic arm. The first portion and the rotatable tool rotate in response to rotation of the end of the rotatable robotic arm. The first portion includes a first conduit passing therethrough and in fluid communication with the vacuum source. The coupler further includes a second portion including a hollow cylindrical interior and positioned around the first portion such that the first portion is fully contained within the hollow cylindrical interior of the second portion. The second portion is fixedly mounted relative to a non-rotatable portion of the rotatable robotic arm such that the second portion does not rotate during rotation of the rotatable robotic arm and the rotatable tool. The coupler further includes a second conduit extending from an exterior surface of the second portion, the second conduit including a proximal opening coupled to the second portion and a distal opening that couples to a first end of a flexible tube having a second end thereof coupled to the vacuum source. The second conduit is in fluid communication with the first conduit and is fixedly mounted relative to the non-rotatable portion of the rotatable robotic arm such that the second conduit does not rotate during the rotation of the rotatable robotic arm and the rotatable tool.

In some embodiments, a method of moving at least one object includes: providing a coupler that couples a vacuum source to a rotatable tool coupled to an end of a rotatable robotic arm that moves the at least one object, the coupler comprising: a first portion coupled to both the rotatable tool and the rotatable robotic arm, the first portion and the rotatable tool rotate in response to rotation of the end of the rotatable robotic arm, wherein the first portion includes a first conduit passing therethrough and in fluid communication with the vacuum source; a second portion including a hollow cylindrical interior and positioned around the first portion such that the first portion is fully contained within the hollow cylindrical interior of the second portion, wherein the second portion is fixedly mounted relative to a non-rotatable portion of the rotatable robotic arm such that the second portion does not rotate during rotation of the rotatable robotic arm and the rotatable tool; a second conduit extending from an exterior surface of the second portion, the second conduit including a proximal opening coupled to the second portion and a distal opening that couples to a first end of a flexible tube having a second end thereof coupled to the vacuum source, wherein the second conduit is in fluid communication with the first conduit, and wherein the second conduit is fixedly mounted relative to the non-rotatable portion of the rotatable robotic arm such that the second conduit does not rotate during the rotation of the rotatable robotic arm and the rotatable tool. The method further includes: bringing the rotatable tool into proximity of the at least one object and activating the vacuum source to hold the at least one object using a vacuum force against a surface of the rotatable tool; moving the at least one object from a first location to a second location while the at least one object is held by the vacuum force against the surface of the rotatable tool; during the moving of the at least one object from a first location to a second location, rotating the rotatable robotic arm to cause rotation of the first portion of the coupler, rotatable tool, and the at least one object moved by the rotatable tool; and during the rotation of the rotatable tool and the at least one object moved by the rotatable tool, not rotating the second portion of the coupler and restricting the second conduit and the flexible tube from rotating.

In some embodiments, a system for moving at least one object includes: a rotatable robotic arm with an end that is coupled to a rotatable tool that moves the at least one object; a vacuum source that is coupled to the rotatable tool to facilitate the rotatable tool to move the at least one object; and a coupler that couples the vacuum source to the rotatable tool coupled to the end of the rotatable robotic arm. The coupler includes: a first portion coupled to both the rotatable tool and the rotatable robotic arm, wherein the first portion and the rotatable tool rotate in response to rotation of the end of the rotatable robotic arm, and wherein the first portion includes a first conduit passing therethrough and in fluid communication with the vacuum source; a second portion including a hollow cylindrical interior and positioned around the first portion such that the first portion is fully contained within the hollow cylindrical interior of the second portion, wherein the second portion is fixedly mounted relative to a non-rotatable portion of the rotatable robotic arm such that the second portion does not rotate during rotation of the rotatable robotic arm and the rotatable tool; and a second conduit extending from an exterior surface of the second portion, the second conduit including a proximal opening coupled to the second portion and a distal opening that couples to a first end of a flexible tube having a second end thereof coupled to the vacuum source, wherein the second conduit is in fluid communication with the first conduit, and wherein the second conduit is fixedly mounted relative to the non-rotatable portion of the rotatable robotic arm such that the second conduit does not rotate during the rotation of the rotatable robotic arm and the rotatable tool.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. A coupler for coupling a vacuum source to a rotatable tool coupled to an end of a rotatable robotic arm for moving at least one object, the coupler comprising:
a first portion coupled to both the rotatable tool and the rotatable robotic arm, wherein the first portion and the rotatable tool rotate in response to rotation of the end of the rotatable robotic arm, and wherein the first portion includes a first conduit passing therethrough and in fluid communication with the vacuum source;
a second portion including a hollow cylindrical interior and positioned around the first portion such that the first portion is fully contained within the hollow cylindrical interior of the second portion, wherein the second portion is fixedly mounted relative to a non-rotatable portion of the rotatable robotic arm such that the second portion does not rotate during rotation of the rotatable robotic arm and the rotatable tool; and
a second conduit extending from an exterior surface of the second portion, the second conduit including a proximal opening coupled to the second portion and a distal opening that couples to a first end of a flexible tube having a second end thereof coupled to the vacuum source, wherein the second conduit is in fluid communication with the first conduit, and wherein the second conduit is fixedly mounted relative to the non-rotatable portion of the rotatable robotic arm such that the second conduit does not rotate during the rotation of the rotatable robotic arm and the rotatable tool.

2. The coupler of claim 1,
wherein at least one of the distal opening and the proximal opening of the second conduit has a cross-section that is rectangular or oval; and/or
wherein the second conduit has a cross-section that is rectangular or oval.

3. The coupler of claim 2, wherein a minor dimension of the cross-section of the second conduit extends parallel to a radial axis of the rotatable robotic arm, and a major dimension of the cross-section of the second conduit extends perpendicular to the radial axis of the rotatable robotic arm.

4. The coupler of claim 1,
wherein the second conduit is coupled to and interconnects the second portion and the non-rotatable portion of the rotatable robotic arm; and
wherein at a central longitudinal axis of the distal opening of the second conduit is parallel to a central longitudinal axis of the hollow cylindrical interior of the second portion.

5. The coupler of claim 4, wherein the second conduit is at least partly curved and extends, from the exterior surface of the second portion toward the end of the rotatable robotic arm, non-perpendicularly relative to the exterior surface of the second portion to form an acute interior angle relative to the exterior surface of the second portion.

6. The coupler of claim 4, wherein a portion of the flexible tube coupled to the distal opening of the second conduit is oriented in parallel to a longitudinal axis of the rotatable robotic arm and to the central longitudinal axis of the hollow cylindrical interior of the second portion.

7. The coupler of claim 1,
wherein the first portion includes a first spindle with a first diameter and coupled to the end of the rotatable robotic arm, and a second spindle with a second diameter and coupled to the rotatable tool; and
wherein the second diameter is larger than the first diameter.

8. The coupler of claim 1, wherein the second portion comprises two hollow semicylinder portions attached to each other to form the hollow cylindrical interior of the second portion, and wherein the second conduit is coupled to and extends from only one of the two hollow semicylinder portions.

9. The coupler of claim 8, wherein each of the two hollow semicylinder portions has an interior surface facing the hollow cylindrical interior of the second portion, and wherein the interior surface of each of the two hollow semicylinder portions includes at least one groove that at least partly receive a complementary shaped and sized exterior-facing surface of the first portion.

10. The coupler of claim 1, wherein no portion of the first portion of the coupler extends out of the hollow cylindrical interior of the second portion of the coupler.

11. A method of moving at least one object, the method comprising:
providing a coupler that couples a vacuum source to a rotatable tool coupled to an end of a rotatable robotic arm that moves the at least one object, the coupler comprising:
a first portion coupled to both the rotatable tool and the rotatable robotic arm, wherein the first portion and the rotatable tool rotate in response to rotation of the end of the rotatable robotic arm, and wherein the first portion includes a first conduit passing therethrough and in fluid communication with the vacuum source;
a second portion including a hollow cylindrical interior and positioned around the first portion such that the first portion is fully contained within the hollow cylindrical interior of the second portion, wherein the second portion is fixedly mounted relative to a non-rotatable portion of the rotatable robotic arm such that the second portion does not rotate during rotation of the rotatable robotic arm and the rotatable tool; and
a second conduit extending from an exterior surface of the second portion, the second conduit including a proximal opening coupled to the second portion and a distal opening that couples to a first end of a flexible tube having a second end thereof coupled to the vacuum source, wherein the second conduit is in fluid communication with the first conduit, and wherein the second conduit is fixedly mounted relative to the non-rotatable portion of the rotatable robotic arm such that the second conduit does not rotate during the rotation of the rotatable robotic arm and the rotatable tool;
bringing the rotatable tool into proximity of the at least one object and activating the vacuum source to hold the at least one object using a vacuum force against a surface of the rotatable tool;
moving the at least one object from a first location to a second location while the at least one object is held by the vacuum force against the surface of the rotatable tool;
during the moving of the at least one object from a first location to a second location, rotating the rotatable robotic arm to cause rotation of the first portion of the coupler, rotatable tool, and the at least one object moved by the rotatable tool; and
during the rotation of the rotatable tool and the at least one object moved by the rotatable tool, not rotating the second portion of the coupler and restricting the second conduit and the flexible tube from rotating.

12. The method of claim 11,
wherein at least one of the distal opening and the proximal opening of the second conduit has a rectangular or an oval cross-section; and/or
wherein the second conduit has a rectangular or an oval cross-section.

13. The method of claim 11,
wherein the second conduit is coupled to and interconnects the second portion and the non-rotatable portion of the rotatable robotic arm;
wherein the second conduit is at least partly curved and extends, from the exterior surface of the second portion toward the end of the rotatable robotic arm, non-perpendicularly relative to the exterior surface of the second portion to form an acute interior angle relative to the exterior surface of the second portion; and
wherein a central longitudinal axis of the distal opening of the second conduit is parallel to a central longitudinal axis of the hollow cylindrical interior of the second portion.

14. The method of claim 11, wherein the first portion includes a first spindle with a first diameter and coupled to the end of the rotatable robotic arm, and a second spindle with a second diameter and coupled to the rotatable tool; and wherein the second diameter is larger than the first diameter.

15. The method of claim 11,
wherein the second portion comprises two hollow semicylinder portions attached to each other to form the hollow cylindrical interior of the second portion, and wherein the second conduit is coupled to and extends from only one of the two hollow semicylinder portions; and
wherein each of the two hollow semicylinder portions has an interior surface facing the hollow cylindrical interior of the second portion, and wherein the interior surface of each of the two hollow semicylinder portions includes at least one groove that at least partly receives a complementary shaped and sized exterior-facing surface of the first portion.

16. A system for moving at least one object, the system comprising:
a rotatable robotic arm with an end that is coupled to a rotatable tool that moves the at least one object;
a vacuum source that is coupled to the rotatable tool to facilitate the rotatable tool to move the at least one object; and
a coupler that couples the vacuum source to the rotatable tool coupled to the end of the rotatable robotic arm, the coupler comprising:
a first portion coupled to both the rotatable tool and the rotatable robotic arm, wherein the first portion and the rotatable tool rotate in response to rotation of the end of the rotatable robotic arm, and wherein the first portion includes a first conduit passing therethrough and in fluid communication with the vacuum source;
a second portion including a hollow cylindrical interior and positioned around the first portion such that the first portion is fully contained within the hollow cylindrical interior of the second portion, wherein the second portion is fixedly mounted relative to a non-rotatable portion of the rotatable robotic arm such that the second portion does not rotate during rotation of the rotatable robotic arm and the rotatable tool; and
a second conduit extending from an exterior surface of the second portion, the second conduit including a proximal opening coupled to the second portion and a distal opening that couples to a first end of a flexible tube having a second end thereof coupled to the vacuum source, wherein the second conduit is in fluid communication with the first conduit, and wherein the second conduit is fixedly mounted relative to the non-rotatable portion of the rotatable robotic arm such that the second conduit does not rotate during the rotation of the rotatable robotic arm and the rotatable tool.

17. The system of claim 16,
wherein at least one of the distal opening and the proximal opening of the second conduit has a rectangular or an oval cross-section; and/or
wherein the second conduit has a rectangular or an oval cross-section.

18. The system of claim 16,
wherein the second conduit is coupled to and interconnects the second portion and the non-rotatable portion of the rotatable robotic arm;
wherein the second conduit is at least partly curved and extends, from the exterior surface of the second portion toward the end of the rotatable robotic arm, non-perpendicularly relative to the exterior surface of the second portion to form an acute interior angle relative to the exterior surface of the second portion; and
wherein and a central longitudinal axis of the distal opening of the second conduit is parallel to a central longitudinal axis of the hollow cylindrical interior of the second portion.

19. The system of claim 16,
wherein an orientation of the second conduit relative to the exterior surface of the second portion of the coupler permits the flexible tube to be coupled to the distal opening of the second portion such that no portion of the flexible tube between the first end of the flexible tube and the second end of the flexible tube has a bend of more than 45 degrees; and
further comprising at least one of electrical connector, ethernet connector, or pneumatic connector passing through the flexible tube.

20. The system of claim 16,
wherein the second portion comprises two hollow semicylinder portions attached to each other to form the hollow cylindrical interior of the second portion, and wherein the second conduit is coupled to and extends from only one of the two hollow semicylinder portions;
wherein each of the two hollow semicylinder portions has an interior surface facing the hollow cylindrical interior of the second portion; and
wherein the interior surface of each of the two hollow semicylinder portions includes at least one groove that at least partly receives a complementary shaped and sized exterior-facing surface of the first portion.
